(19) United States
(12) Patent Application Publication
(10) Pub. No.: US 2021/0107779 A1
(43) Pub. Date: Apr. 15, 2021

(54) Vessel Filling and Capping System

(71) Applicant: Ryan Allen, Breeding, KY (US)

(72) Inventor: Ryan Allen, Breeding, KY (US)

(21) Appl. No.: 17/065,512

(22) Filed: Oct. 7, 2020

Related U.S. Application Data
(60) Provisional application No. 62/914,708, filed on Oct. 14, 2019.

(51) Int. Cl. B67B 3/20; B67C 3/26; B67C 3/24; B67C 3/00; B67B 3/26

(52) U.S. Cl. CPC B67B 3/2053; B67C 3/26; B67B 3/261; B67C 3/007; B67C 3/24

(57) ABSTRACT

A vessel filling and capping system is described. Embodiments of the vessel filling and capping system can include, but is not limited to, a vessel filling assembly, a vessel capping assembly, and a tray. The vessel filling assembly can be implemented to fill one or more vessels with a fluid and the vessel capping assembly can be implemented to cap the filled one or more vessels. The tray can be implemented to hold the one or more vessels and align the vessels for the vessel filling assembly and the vessel capping assembly.

### CROSS-REFERENCE TO RELATED APPLICATION

This application claims the benefit of U.S. Provisional Application No. 62/914,708, filed Oct. 14, 2019.

### BACKGROUND

Currently, there is a need for small bottling capabilities where the cost of equipment for larger scale operations are cost prohibitive. Many different means are known for effectively and efficiently filling bottles in large scale operations. Conveyor type systems are well known and work great for large scale operations where the costs of machinery can be economically feasible. However, for smaller operations, these types of systems are cost prohibitive and economically unfeasible.

A system for bottling (i.e., filling and capping) on a small scale (e.g., 10-100 bottles at a time) that is economically feasible, easy to use, and labor efficient is needed.

### BRIEF DESCRIPTION OF THE DRAWINGS

FIG. 1A is a block diagram of a vessel filling and capping system according to one embodiment of the present invention.

FIG. 1B is a detailed block diagram of a vessel filling and capping system according to one embodiment of the present invention.

FIG. 1C is a block diagram of a control module according to one embodiment of the present invention.

FIG. 1D is a screenshot of a user interface for a vessel filling assembly according to one embodiment of the present invention.

FIG. 1E is a screenshot of a user interface for a vessel capping assembly according to one embodiment of the present invention.

FIG. 2A is a detailed diagram of a vessel filling assembly according to one embodiment of the present invention.

FIG. 2B is a detailed diagram of a support frame and a tray support member according to one embodiment of the present invention.

FIG. 3 is a detailed diagram of a vessel capping assembly according to one embodiment of the present invention.

FIG. 4 is a detailed diagram of a tray and a vessel according to one embodiment of the present invention.

FIG. 5 is a detailed diagram of a vessel filling assembly according to one embodiment of the present invention.

### DETAILED DESCRIPTION

Embodiments of the present invention include a vessel filling and capping (VFC) system. The VFC system can be implemented to fill a plurality of vessels with fluid and secure caps to the filled vessels. In one embodiment, the VFC system can include, but is not limited to, a control module, a tray, a vessel filling assembly, and a vessel capping assembly. Typically, the tray can be implemented with both the vessel filling assembly and the vessel capping assembly. For instance, after a plurality of vessels are filled with a fluid via the vessel filling assembly, the tray having fluid filled vessels can be implemented with the vessel capping assembly to secure caps to each of the filled vessels. Typically, the tray can be removed from the vessel filling assembly and then moved to the vessel capping assembly after the vessels have been filled. The vessel capping assembly may then cap each of the fluid filled vessels in the tray.

The tray can typically include a matrix (or grid) of receptacles for receiving vessels therein. A size of the tray can be varied depending on a need of a particular user. Based on a size of the vessels to be filled, the tray may include differing amounts of receptacles. Of note, the vessels can typically be bottles configured to receive a threaded cap thereon. For instance, a size of the receptacles can be altered to fit a variety of differently sized vessels on a similarly sized tray. In one example, the tray may include an 7×8 matrix of receptacles. In another example, the tray may include a 5×4 matrix of receptacles. Typically, the tray can be sized to be implemented with both the vessel filling assembly and the vessel capping assembly. Typically, vessels loaded into the tray can be filled with the vessel filling assembly and then the tray can be removed with the filled vessels and moved to the vessel capping assembly to be capped.

In one embodiment, the vessel filling assembly can include, but is not limited to, a control module, a support frame, a first linear actuator, a second linear actuator, a tray support member, a nozzle, a pump, and a power supply. The support frame can be implemented to support the first linear actuator, the second linear actuator, the tray support member, and the nozzle. The first linear actuator can be operatively coupled to the tray support member and the second linear actuator can be operatively coupled to the nozzle. Typically, a direction of motion of the first linear actuator can be oriented perpendicular to a direction of motion of the second linear actuator. For instance, a stroke of the first linear actuator can be substantially perpendicular to a stroke of the second linear actuator. Of note, this allows the control module to orient a location of the nozzle in relation to the tray based on a movement of the first linear actuator and the second linear actuator. For instance, an XY coordinate system (e.g., Cartesian coordinate system) can be implemented. The control module may then dictate a location of the nozzle by moving the first linear actuator and the second linear actuator.

Embodiments are contemplated where a vision sensor can be implemented to determine a location of a vessel and an amount of fluid filled into the vessels. In such an embodiment, a user my input how many rows and columns for the tray and a total number of vessels to be filled. The user may also input a fill volume and a sensor offset. The control module may index the nozzle over until the vision sensor indicates finding a first vessel and then the control module can start the pump to fill the first vessel based on information from the vision sensor. The control module can stop filling the first vessel when the vision sensor indicates the vessel is full. The control module may then index the nozzle to the next vessel until the vision sensor detects the next vessel. The control module may start the pump and continue the process until all the vessels have been filled. As can be appreciated, when implementing the vision sensor, the control module can determine when to begin filling and/or moving the nozzle based on data received from the vision sensor.

The first linear actuator, the second linear actuator, and the pump can be controlled via the control module. The tray support member can include guides for placing the tray in an appropriate location on the tray support member. In one example, protrusions located on back corners and sides of the tray support member can be implemented.

Generally, the pump may be a peristaltic pump. However, other types of pumps are contemplated for use with the system. Of note, the assembly can include one or more peristaltic pumps depending on the number of nozzles implemented. Generally, there can be a one-to-one ratio of pumps to nozzles. The nozzle and pump can be implemented to deposit fluids including oils to lotions. For instance, the assembly can be rated for low and high viscosities (cP) 20000+. In other embodiments, typically for high viscosity fluids, a piston pump may be implemented. In yet other embodiments, pressurized storage containers may be used in combination with a peristatic pump to fill the vessels based on volume. In embodiments implementing a pressurized storage container, the peristatic pump can be implemented to meter the amount of fluid being dispensed. As can be appreciated, the pressurized storage container can provide enough force to effectively pump the fluid.

In some embodiments, the vessel filling assembly may further include a third linear actuator configured to adjust a vertical position of the nozzle. In such an embodiment, the nozzle may be moved into an interior of a vessel to fill the vessel from the bottom up. After, or during the filling, the nozzle can be moved up and then out of the vessel after the vessel has been filled. The third linear actuator may be controlled via the control module.

In some instances, a tray may be filled with vessels having varying heights. Typically, the vessels can be grouped together in the tray with similarly sized vessels and the control module may be provided (e.g., by a user via a user interface) a location of the change in size of vessels. The vessel filling assembly may then adjust a vertical location of the nozzle when the vessels change height. Embodiments are contemplated where a vertical position of the nozzle may be manually adjusted.

In one embodiment, the vessel capping assembly can include, but is not limited to, a control module, a support frame, a first linear actuator, a second linear actuator, a tray support member, a compressed gas source, a pneumatic torque wrench, a pneumatic cylinder, and a power supply. The support frame can be implemented to support the first linear actuator, the second linear actuator, the tray support member, the pneumatic torque wrench, and the pneumatic cylinder. The compressed air source can be operatively connected to the pneumatic torque wrench and the pneumatic cylinder. The pneumatic cylinder can be implemented to move the pneumatic torque wrench up and down. The first linear actuator, the second linear actuator, the pneumatic torque wrench, and the pneumatic cylinder can be controlled via the control module. The tray support member can include guides for placing the tray in an appropriate location on the tray support member. In one example, protrusions located on back corners and sides of the tray support member can be implemented. In one embodiment, an electric torque wrench can be implemented in place of the pneumatic torque wrench and a linear actuator can be implemented in place of the pneumatic cylinder. In some instances, the electric torque wrench can be implemented with the pneumatic cylinder or the pneumatic torque wrench can be implemented with the linear actuator.

The first linear actuator can be operatively coupled to the tray support member and the second linear actuator can be operatively coupled to the pneumatic torque wrench and the pneumatic cylinder. Typically, a direction of motion of the first linear actuator can be oriented perpendicular to a direction of motion of the second linear actuator. For instance, a stroke of the first linear actuator can be substantially perpendicular to a stroke of the second linear actuator. Of note, this allows the control module to orient a location of the pneumatic torque wrench in relation to the tray based on a movement of the first linear actuator and the second linear actuator. For instance, an XY coordinate system (e.g., Cartesian coordinate system) can be implemented. The control module may then dictate a location of the pneumatic torque wrench by moving the first linear actuator and the second linear actuator.

The control module can include an application (or program) configured to operate one or more components of the VFC system. In one instance, a control module can be provided for the vessel filling assembly and another control module can be provided for the vessel capping assembly. In another instance, a single computing device running two different applications (or programs or combination thereof) can be implemented for both the vessel filling assembly and the vessel capping assembly. The control module can represent a computing device or another powerful, dedicated computer system that can support multiple user sessions. In some embodiments, the control module can be any type of computing device including, but not limited to, a personal computer, a game console, a smartphone, a tablet, a netbook computer, or other computing devices. In one embodiment, the control module can be a distributed system wherein server functions are distributed over several computers connected to a network. The control module can typically include a hardware platform and software components.

The software components of the control module can include one or more databases which can store a data related to positional information for the tray matrix. The software components can also include an operating system on which various applications and programs can execute. The control module can include one or more applications dedicated to operating the vessel filling assembly and the vessel capping assembly. The applications can include user interfaces utilizing inputs and actionable buttons to allow a user to control the assemblies via the applications. A database manager can be an application that runs queries against the databases. In one embodiment, the database manager can allow interaction with the databases through an HTML user interface on a user device.

The hardware platform of the control module can include, but is not limited to, a processor, random-access memory, and nonvolatile storage. The processor can be a single microprocessor, multi-core processor, or a group of processors. The random-access memory can store executable code as well as data that can be immediately accessible to the processor. The nonvolatile storage can store executable code and data in a persistent state. The hardware platform can include a user interface. The user interface can include keyboards, monitors, pointing devices, and other user interface components. The hardware platform can also include a network interface. The network interface can include, but is not limited to, hardwired and wireless interfaces through which the control module can communicate with other devices.

In a typical implementation of the vessel filling and capping system, a plurality of vessels can be placed into the tray. A user can then use the vessel filling assembly to fill each of the plurality of vessels with a fluid selected by the user. Of note, the VFC system application can be configured to allow a user to determine a fill speed of the assembly to allow adjustability for fluids having different viscosities and for vessels having differing volumes. Once each of the vessels has been filled, the tray full of vessels can be removed from the vessel filling assembly and moved to the vessel capping assembly. The tray, full of filled vessels, can be placed on the tray support member of the vessel capping assembly and moved into position for interaction with the pneumatic torque wrench. Once the tray full of vessels if properly oriented, the vessel capping assembly can be implemented to cap each of the vessels.

The present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

### An Embodiment of a Vessel Filling and Capping System

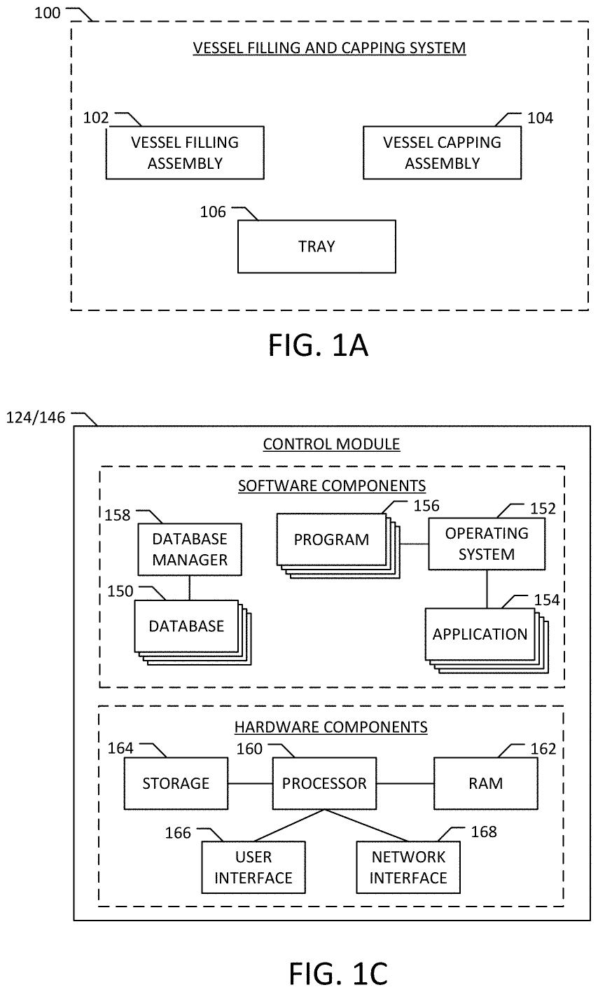

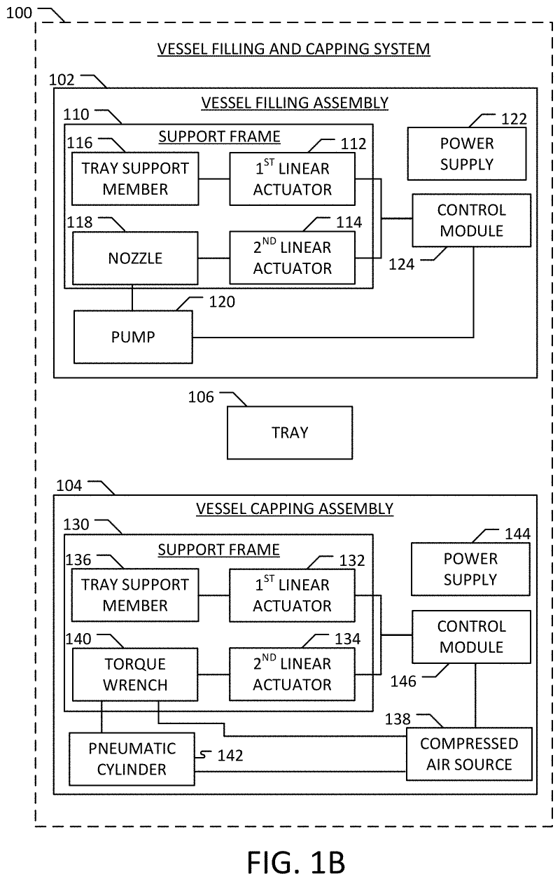

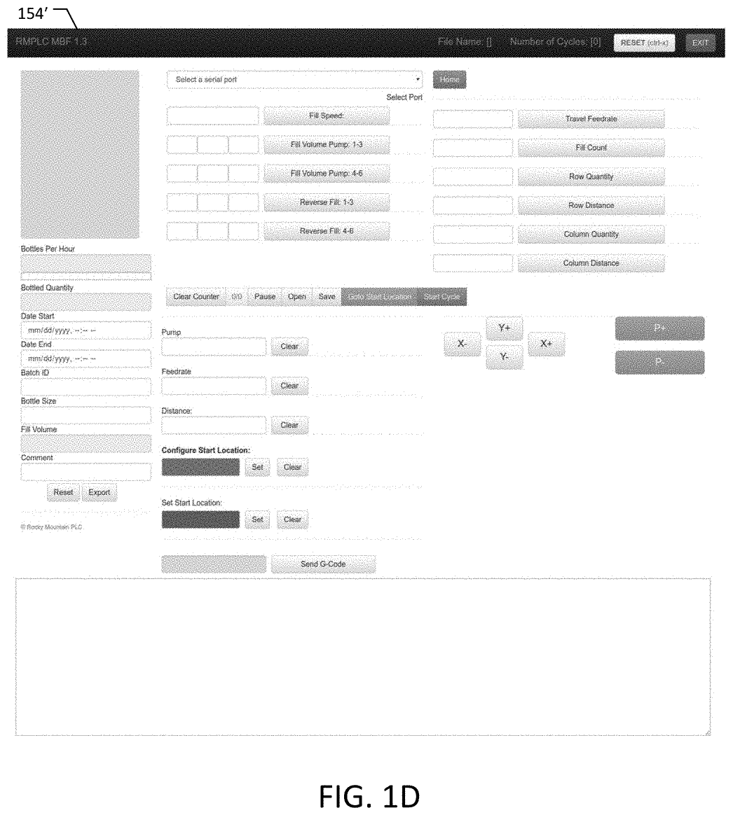

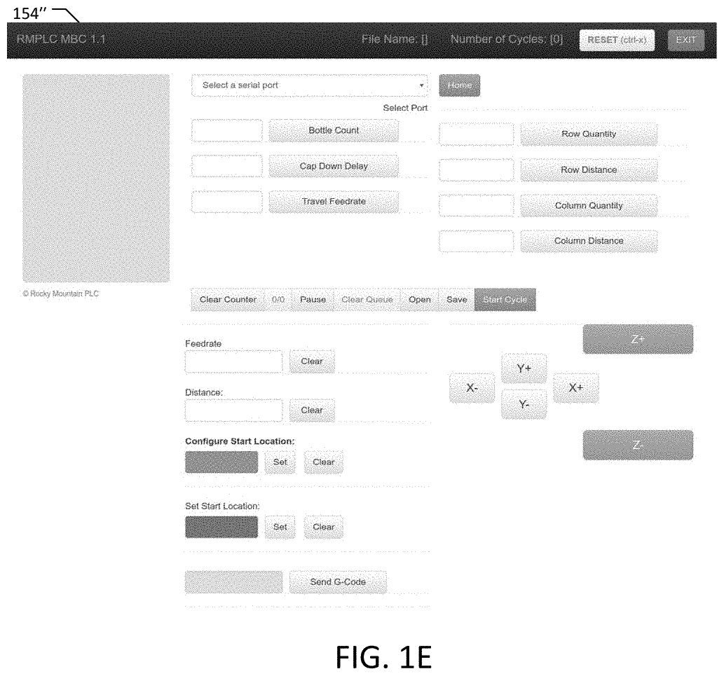

Referring to FIGS. 1A-1C, block diagrams of an embodiment 100 of a vessel filling and capping system is illustrated. The vessel filling and capping (VFC) system 100 can be implemented to fill and cap a plurality of vessels with a fluid. Of note, fluids having a wide range of viscosities can be used in the VFC system 100.

As shown in FIG. 1A, the VFC system 100 can include, but is not limited to, a vessel filling assembly 102, a vessel capping assembly 104, and a tray 106. The tray 106 can be configured to work with both the vessel filling assembly 102 and the vessel capping assembly 104. For instance, the tray 106 may be loaded onto the vessel filling assembly 102, removed after having vessels be filled with a fluid, and then moved to the vessel capping assembly 104 to have the fluid filled vessels capped.

Referring to FIG. 1B, a detailed block diagram of one example embodiment of the vessel filling assembly 102 and a detailed block diagram of one example embodiment of the vessel capping assembly 104 are illustrated.

The vessel filling assembly 102 can include, but is not limited to, a support frame 110, a first linear actuator 112, a second linear actuator 114, a tray support member 116, a nozzle 118, a pump 120, a power supply 122, and a control module 124. The support frame 110 can be implemented to support the first linear actuator 112, the second linear actuator 114, the tray support member 116, and the nozzle 118. The first linear actuator 112 can be operatively coupled to the tray support member 116 and the second linear actuator 114 can be operatively coupled to the nozzle 118. Typically, a direction of motion of the first linear actuator 112 can be oriented perpendicular to a direction of motion of the second linear actuator 114. Of note, this can allow the control module 124 to orient a location of the nozzle 118 in relation to the tray 106 based on a movement of the first linear actuator 112 and the second linear actuator 114. For instance, an XY coordinate system (e.g., Cartesian coordinate system) can be implemented to control a location of the nozzle 118 and the tray 106 by the control module 124.

In a typical implementation, the first linear actuator 112, the second linear actuator 114, and the pump 120 can be controlled via the control module 124. The tray support member 116 can include guides for placing the tray 106 in an appropriate location on the tray support member 116. In one example, protrusions located on back corners and sides of the tray support member 116 can be implemented.

Generally, the pump 120 may be a peristaltic pump. However, other types of pumps are contemplated for use with the system. Of note, the assembly 102 can include one or more peristaltic pumps depending on the number of nozzles implemented. Generally, there can be a one-to-one ratio of pumps to nozzles. The nozzle and pump can be implemented to deposit fluids including oils to lotions. For instance, the assembly can be rated for low and high viscosities (cP) 20000+. In other embodiments, typically for high viscosity fluids, a piston pump may be implemented. In yet other embodiments, pressurized storage containers may be used in combination with a peristatic pump to fill the vessels based on volume. In embodiments implementing a pressurized storage container, the peristatic pump can be implemented to meter the amount of fluid being dispensed. As can be appreciated, the pressurized storage container can provide enough force to effectively pump the fluid.

The vessel capping assembly 104 can include, but is not limited to, a support frame 130, a first linear actuator 132, a second linear actuator 134, a tray support member 136, a compressed gas source 138, a pneumatic torque wrench 140, a pneumatic cylinder 142, a power supply 144, and a control module 146. The support frame 130 can be implemented to support the first linear actuator 132, the second linear actuator 134, the tray support member 136, the pneumatic torque wrench 140, and the pneumatic cylinder 142. The compressed air source 138 can be operatively connected to the pneumatic torque wrench 140 and the pneumatic cylinder 142. The pneumatic cylinder 142 can be implemented to move the pneumatic torque wrench 140 up and down. The first linear actuator 132, the second linear actuator 134, the pneumatic torque wrench 140, and the pneumatic cylinder 142 can be controlled via the control module 146. In one instance, the pneumatic torque wrench 140 can be a push to start wrench where work can be initiated when the torque wrench engages a cap on a vessel. The tray support member 136 can include guides for placing the tray 106 in an appropriate location on the tray support member 136. In one example, protrusions located on back corners and sides of the tray support member 136 can be implemented.

The first linear actuator 132 can be operatively coupled to the tray support member 136 and the second linear actuator 134 can be operatively coupled to the pneumatic torque wrench 140 and the pneumatic cylinder 142. Typically, a direction of motion of the first linear actuator 132 can be oriented perpendicular to a direction of motion of the second linear actuator 134. Of note, this can allow the control module 146 to orient a location of the pneumatic torque wrench 140 in relation to the tray 106 based on a movement of the first linear actuator 132 and the second linear actuator 134. For instance, an XY coordinate system (e.g., Cartesian coordinate system) can be implemented to control a location of the pneumatic torque wrench 140 and the tray 106 by the control module 146.

Referring to FIG. 1C, a block diagram of an example embodiment of the filling control module 124 and the capping control module 146 is illustrated. In some embodiments, the control module 124 of the vessel filling assembly 102 can be implemented as the control module 146 of the vessel capping assembly 104.

As shown, the control module 124/146 can include, but is not limited to, software components and hardware components. The software components of the control module 124/146 can include one or more databases 150 which can store a data related to positional information for the tray matrix. The software components can also include an operating system 152 on which various applications 154 and programs 156 can execute. A database manager 158 can be an application that runs queries against the databases 150. In one embodiment, the database manager 158 can allow interaction with the databases 150 through an HTML user interface on a user device.

The hardware platform of the control module can include, but is not limited to, a processor 160, random-access memory 162, and nonvolatile storage 164. The processor 160 can be a single microprocessor, multi-core processor, or a group of processors. The random-access memory 162 can store executable code as well as data that can be immediately accessible to the processor. The nonvolatile storage 164 can store executable code and data in a persistent state. The hardware platform can include a user interface 166. The user interface 166 can include keyboards, monitors, touchscreens, pointing devices, and other user interface components. Typically, the software components can be displayed on the user interface 166. The hardware platform can also include a network interface 168. The network interface 168 can include, but is not limited to, hardwired and wireless interfaces through which the control module 124/146 can communicate with other devices.

The control module 124/146 can represent a computing device or another powerful, dedicated computer system that can support multiple user sessions. In some embodiments, the control module 124/146 can be any type of computing device including, but not limited to, a personal computer, a game console, a smartphone, a tablet, a netbook computer, or other computing devices. In one embodiment, the control module 124/146 can be a distributed system wherein server functions are distributed over several computers connected to a network. The control module 124/146 can typically include a hardware platform and software components.

As shown in FIG. 1B, the filling control module 124 can be operatively connected to the first linear actuator 112, the second linear actuator 114, and the pump 120. The control module 124 can be implemented to determine how far the first linear actuator 112 and the second linear actuator 114 move and which direction to move. The control module 124 can further be configured to determine how long to run the pump 120 to fill a vessel having a predetermined volume. As can be appreciated, the control module 124 can move the tray 106 and the nozzle 118 to locate the nozzle 118 approximate a center of each of the vessels in the tray 106. The control module 124 can run the pump 120, which can be fluidly connected to the nozzle 118, to fill each of the vessels.

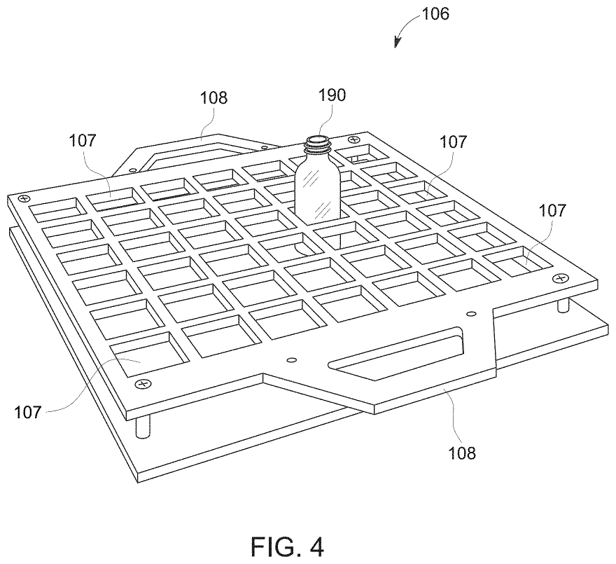

As previously mentioned, the tray 106 (as shown in FIG. 4) can include a plurality of receptacles oriented in a grid shape. Typically, the tray 106 can include one or more columns and one or more rows of receptacles forming the grid. In one embodiment, the control module 124 can be configured to position a location of the nozzle 118 using Cartesian coordinates based on the rows (x) and columns (y) of the tray 106. To position the nozzle 118, the control module 124 can move the tray support member 116 via the first linear actuator 112 back and forth in relation to the nozzle 118. The control module 124 can move the nozzle 118 side to side via the second linear actuator 114. Effectively, the first linear actuator 112 can control movement for the “Y” coordinate and the second linear actuator 114 can control movement for the “X” coordinate.

The tray 106 may be placed on the filling tray support member 116 and the guides 117 can be implemented to orient the tray 106 on the vessel filling assembly 102. The control module 124 can run an application with one or more inputs from a user to center the nozzle 118 over a first vessel located in the tray 106. The application can further allow a user to input information related to a distance between bottles located proximate to one another to help determine how far the nozzle travels after filling a vessel.

The capping control module 146 can be operatively connected to the first linear actuator 132, the second linear actuator 134, and the pneumatic cylinder 142. Of note, the capping control module 146 can effectively control the pneumatic torque wrench 140 via the pneumatic cylinder 142. Similar to the filling control module 124, the capping control module 146 can include one or more inputs in an application to determine a location of the pneumatic cylinder 142 in relation to vessels in the tray 106. To position the pneumatic torque wrench 140, the control module 146 can move the tray support member 136 via the first linear actuator 132 back and forth in relation to the pneumatic torque wrench 140. The control module 146 can move the pneumatic torque wrench 140 side to side via the second linear actuator 134. Effectively, the first linear actuator 132 can control movement for the “Y” coordinate and the second linear actuator 134 can control movement for the “X” coordinate.

Referring to FIG. 1D, a screenshot of an application 154′ running on the control module 124 for implementing and controlling various components of the vessel filling assembly 102 are illustrated. Typically, the user interface can include a plurality of inputs for providing data to the control module 124 and data displays for providing information to a user. Various operating parameters of the vessel filling assembly 102 can be set by a user when using the application 154′.

FIG. 1D includes a screenshot of the user interface of the application 154′ on the control module 124 for adjusting how the components of the vessel filling assembly 102 operate. As shown, the application 154′ can include, but is not limited to, the following inputs, data displays, and actionable buttons. A data display “File name” can show which program is currently opened. The program may store a plurality of input parameters from a previously run operation. An actionable button “Home” may return the first linear actuator and the second linear actuator to a home position. Typically, a user may “Home” the assembly 102 any time the assembly 102 is powered up or to reset the assembly 102. A data display “Number of Cycles” can determine how many times the assembly has been previously ran. An actionable button “Reset” can perform a soft reset to stop the assembly 102 from operating. An actionable button “Exit” can be used to exit out of the user interface. A data display “Status” can display a current status of the assembly 102. A data display “Terminal” can be used to see a current status of the assembly 102 line by line. A data display “Bottles Per Hour” can present how many bottles per hour a user is running. A data display “Bottle Quantity” can present how many bottles have been filled by the assembly 102. An input “Fill Count” can allow a user to tell the assembly 102 how many bottles to fill per cycle. Of note, in embodiments where a single nozzle is implemented, this may be labeled as “Bottle Count.” An input “Fill Speed” can allow a user to set how fast to fill the bottles. For instance, this can adjust how fast the pump runs. An input “Fill Volume” can allow a user to set how much product to fill into each container. Of note, in embodiments where multiple pumps are implemented, each input box can be for each pump head. In some embodiments, you can have up to six pumps. An input “Reverse Fill” can allow a user to set the pump to reverse (or suck back) product to stop dripping after each fill. An input “Travel Feedrate” can allow a user to set how fast the machine moves from container to container. An input “Row Quantity” can a user to set how many rows are on the tray. Of note, rows can be defined on the tray 106 from back to front. An input “Row Distance” can allow a user to adjust a spacing between each row. An input “Column Quantity” can allow a user to adjust how many columns there are on the tray. Of note, columns can be defined from right to left on the tray 106. An input “Column Distance” can allow a user to adjust a space between each column. An input “Nozzle Distance” can allow a user to adjust how far down the nozzle travels to insert into a container. Of note, some embodiments are contemplated where the nozzle does not move up and down. An input “Nozzle Clearance” can be used to adjust how far the nozzle moves upwards after filling to clear a top of the container before moving to the next container.

The application 154′ can further include, but is not limited to, the following inputs, data displays, and actionable buttons. A data display “Date Start” can show a user a date when a tray full of containers was started to be filled. A data display “Date End” can let the user know a date when the containers were all filled. A data display “Batch ID” can display a batch number for data collected. A data display “Bottle size” can tell a user a size of containers being filled. A data display “Fill Volume Total” can let a user know a programmed volume being filled. An input “Comment” can allow a user to type in notes about a current set of containers being filled. An actionable button “Reset” can be used by a user to reset collected data. An actionable button “Export” can be used by a user to export data collected to a CSV file in one instance. It is to be appreciated that other file formats can be implemented. An actionable button “Clear Counter” can be used by a user to clear a cycle count. A data display “Status” can present how many commands are left to a user. An actionable button “Pause” can be use by a user to pause filling mid cycle. An actionable button “Open” can be used by a user to open a saved program. An actionable button “Save” can be used to save a program. An actionable button “Go to Start Location” can be used to send the tray support member to a start location entered into the input “Set Start Location” box. An actionable button “Start Cycle” can be used to start a filling cycle. An input “Pump Pick” can be implemented to select a pump to run manually. An input “Feedrate” can be used to control a speed of the pumps and axis for manual movements. An input “Distance” can be used to determine how far to manually move an axis or pump. An input “Configure Start Location” can be used to set a new start location. An actionable button “Set Start Location” can be used to set which start location to use. An actionable button and input “Send Gcode” can be used to send commands for debugging. In embodiments including a third linear actuator, the application 154′ can include an actionable button “Z+” to jog the nozzle up and an actionable button “Z−” to jog the nozzle down. The actionable buttons “Z+” and “Z−” are not illustrated. An actionable button “X−” can be used to jog the nozzle left. An actionable button “X+” can be used to jog the nozzle right. An actionable button “Y+” can be used to jog the tray away from a user. An actionable button “Y−” can used to jog the tray towards a user. An actionable button “P+” can be used to jog the pump to fill. An actionable button “P−” can used to jog the pump to reverse (or suck back).

Referring to FIG. 1E, a screenshot of an application 154″ running on the control module 146 for implementing and controlling various components of the vessel capping assembly 104 are illustrated. In some embodiments, an independent application for each of the assemblies 102, 104 may be implemented. In other embodiments, a single application can be implemented to control each of the assemblies 102, 104. Various operating parameters for the vessel capping assembly 104 can be set by a user when using the application 154″.

As shown, the application 154″ can include, but is not limited to, the following inputs, data displays, and actionable buttons. A data display “File Name” can show a current program name. A data display “Machine Status” can display a status of the assembly 106 in a line-by-line format. An actionable button “Home” can be used to return the first linear actuator and the second linear actuator to a “home” position. An input “Bottle Count” can list how many containers are to be capped. An input “Cap Down Delay” can determine how long the capping assembly 106 will try to cap the containers. An input “Travel Feedrate” can be used to control how fast the torque wrench will travel from container to container. A data display “Cycle Count” can show how many cycles have been completed (next to “File Name”). An input “Row Quantity” can be used to determine how many containers are to be filled in each row. Of note, different trays can have different amounts of rows. In one instance, rows go from front to back if looking straight at the capping assembly 106. An input “Row Distance” can be used to enter a distance from a center of a container to a center of a container next to it. An input “Column Quantity” Different bottle trays have different amounts of columns. In one instance, columns go from left to right if looking straight at the capping assembly 104. This setting may be saved when a user saves program settings. An input “Column Distance” can be used to determine a distance between centers of containers in the column. An actionable button “Reset” can be used to perform a soft stop if something is not running right. An actionable button “Exit” can be used to exit out of the user interface. An actionable button “Clear Counter” can clear a cycle number. An actionable button “Pause” can be used to pause the capping assembly 104 mid cycle. An actionable button “Start Cycle” can be used to start the process for capping containers. An input “Feedrate” can be used to set a travel speed or pump speed. An input “Distance” can be used to set a travel distance or pump distance. An input “Configure Start Location” can be used to setup one or more start locations for a plurality of trays. An actionable button “Set Start Location” can implement a drop-down menu to tell the capping assembly 104 which pre-defined location to use. An actionable button “X−” can jog (e.g., moves) the torque wrench left. An actionable button “Y−” can jog the torque wrench forward. An actionable button “X+” can job the torque wrench to the right. An actionable button “X+” can jog the torque wrench backwards. An actionable button “Z+” can jog the torque wrench up. An actionable button “Z−” can jog the torque wrench down.

Of note, the previously described screenshots are for illustrative purposes and not meant to be limiting.

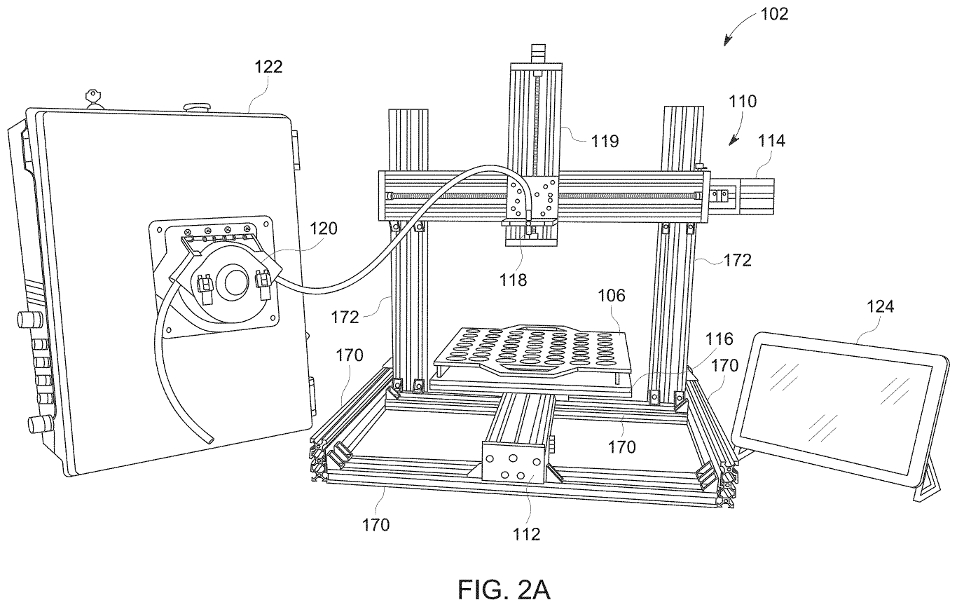

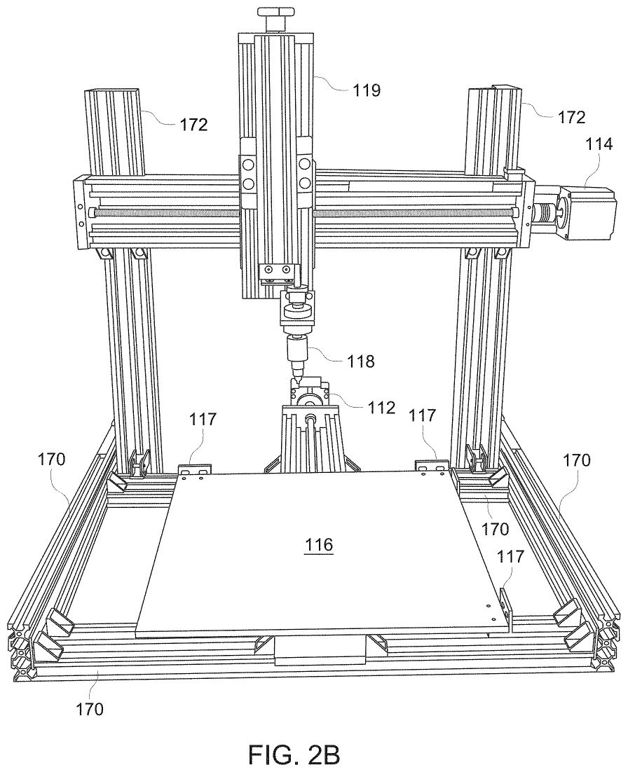

Referring to FIG. 2A, a perspective view of the vessel filling assembly 102 is illustrated. Referring to FIG. 2B, a close-up view of the support frame 110 and the tray support member 116 are illustrated. As previously mentioned, the tray support member 116 can include one or more guides 117 (shown in FIG. 2B) to properly position the tray 106 when placed on the tray support member 116.

Referring generally to FIGS. 2A-2B, an example embodiment of the support frame 110 is illustrated. As shown, the support frame 110 can include, but is not limited to, a plurality of base members 170 forming a substantially rectangular base and a pair of vertical members 172 extending up from the base members 170. The first linear actuator 112 can be coupled to parallel base members 170 and the second linear actuator 114 can be coupled to the vertical members 172. The nozzle 118 may be operatively connected to the second linear actuator 114 via a nozzle attachment member 119. The nozzle attachment member 119 can be moved via the second linear actuator 114. In some embodiments, the nozzle attachment member 119 can be adapted to move the nozzle 118 up and down. For instance, the nozzle attachment member 119 can include a mechanical mechanism for moving the nozzle 118 up and down. In another instance, the control module 124 may be operatively coupled to the nozzle attachment member 119 to determine when to move the nozzle 118 up and down. For example, a third linear actuator may be implemented to control a movement of the nozzle 118 up and down.

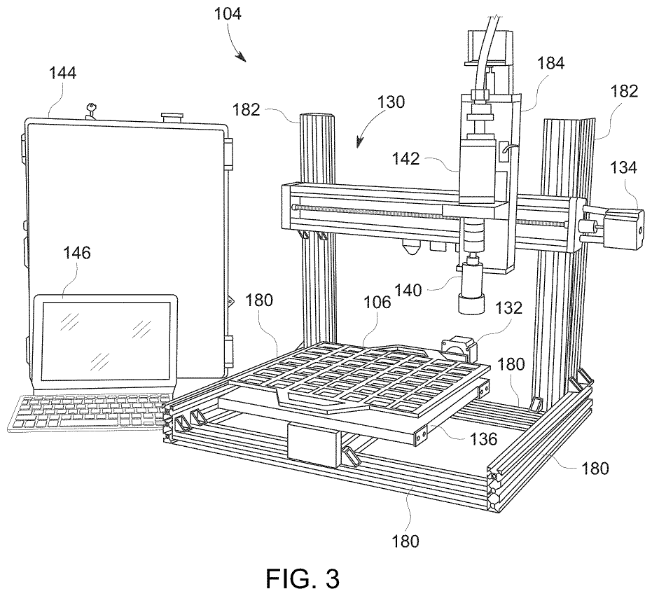

Referring to FIG. 3, a perspective view of the vessel capping assembly 104 is illustrated. As previously mentioned, the vessel capping assembly 104 can be implemented to receive the tray 106 thereon and cap one or more vessels previously filled via the vessel filling assembly 102. Of note, the vessel capping assembly 104 can be implemented to fill vessels filled via another means than the vessel filling assembly 102.

An example embodiment of the support frame 130 is illustrated. As shown, the support frame 130 can include, but is not limited to, a plurality of base members 180 forming a substantially rectangular base and a pair of vertical members 182 extending up from the base members 180. The first linear actuator 132 can be coupled to parallel base members 180 and the second linear actuator 134 can be coupled to the vertical members 182. The pneumatic cylinder 142 may be coupled to the second linear actuator 114 via an attachment member 184. The attachment member 184 can be moved via the second linear actuator 134.

Referring to FIG. 4, a perspective view of one example embodiment of the tray 106 and a vessel 190 is illustrated. As previously mentioned, the tray can include a matrix (or grid) of receptacles 107 for receiving vessels therein and one or more handles 108. The handles 108 can be implemented to transport the tray 106 between the vessel filling assembly 102 and the vessel capping assembly 104. By implementing an XY coordinate system and the tray 106 having a grid, the control module 124/146 can be configured to determine a location of each vessel loaded into the tray 106 based on inputs received from a user. Information about the tray 106 can be provided to the applications 154 running on the control module 124/146.

The vessel 190 can typically be a bottle (or another container) configured to receive a threaded cap thereon. The tray 106 can be sized to be implemented with both the vessel filling assembly 102 and the vessel capping assembly 104. Typically, vessels loaded into the tray 106 can be filled with the vessel filling assembly 102 and then the tray 106 can be removed with the filled vessels and moved to the vessel capping assembly 104 to be capped. Embodiments are contemplated where a plate can be placed on top of the tray 106 to reduce a size of the receptacles. For instance, a plate with smaller sized apertures can be placed on top of the tray 106.

### A Second Embodiment of a Vessel Filling Assembly

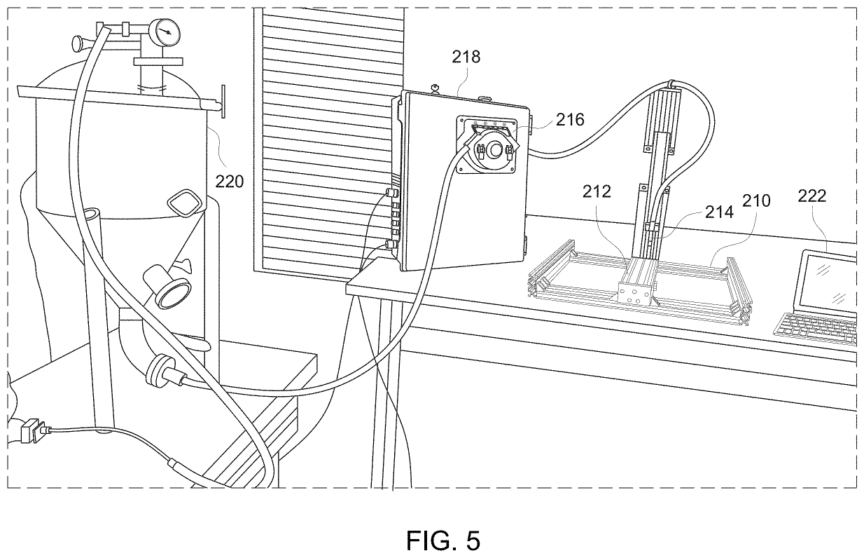

Referring to FIG. 5, a detailed diagram of an embodiment 200 of a vessel filling assembly including a pressurized storage tank is illustrated. The second embodiment vessel filling assembly 200 can typically be implemented when working with higher viscosity fluids and/or as a volumetric filler. The second embodiment vessel filling assembly 200 can be implemented with the tray 106 and the vessel capping assembly 104 to fill one or more vessels and cap the vessels while stored in the tray 106.

As shown, the second embodiment vessel filling assembly 200 can include several components similar to the first embodiment vessel filling assembly 102. The vessel filling assembly 200 can include, but is not limited to, a support frame 210, a tray support member 212, a nozzle 214, a pump 216, a power supply 218, a pressure vessel 220, and a control module 222. In some embodiments, the support frame 210, the tray support member 212, and the nozzle 214 can be configured substantially similar to the first embodiment vessel filling assembly 102. In said embodiments, a first linear actuator 224 and a second linear actuator 226 can be implemented substantially similar to the first embodiment linear actuators 112, 114.

The pressure vessel 220 can be operatively connected to the pump 216 and can store fluid to be deposited into vessels. Typically, the pump 216 can be a peristaltic pump. By implementing a peristaltic pump, the vessel filling assembly 200 may accurately fill each vessel with a substantially equal amount of fluid. For instance, the peristaltic pump 216 can meter fluid being moved from the pressurized vessel 220 to a vessel. The pressurized vessel 220 can help ensure that viscous fluids are continuously and fully (e.g., without air pockets) pumped to the vessels. Further, the pressurized vessel 220 can allow for the peristaltic pump 216 to quickly fill each vessel.

In a typical implementation, the pressure vessel 220 can be filled with a fluid to be deposited into one or more vessels. After the fluid has been deposited into the pressure vessel 220, the pressure vessel 220 can be pressurized. Typically, a tube can fluidly connect the pressure vessel 220 to the peristaltic pump 216. A tube can then connect the peristaltic pump 216 to the nozzle 214. The control module 222 can be implemented when to turn the pump 216 on and off to fill each of the vessels. The control module 222 can further be implemented to activate the first linear actuator 224 (and the second linear actuator 226 when setup similar to the first embodiment vessel filling assembly 102) to position the tray 106 at an appropriate location for the nozzle 214 to fill a vessel.

As can be appreciated, the pressure vessel 220 can be operatively connected to a gas source to pressurize the pressure vessel 220. In some embodiments, the gas source may be operatively connected to the vessel capping assembly 104.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A vessel filling and capping system comprising:
a vessel filling assembly including:
a filling support frame;
a filling tray support member;
a nozzle;
a first filling linear actuator (i) operatively coupled to the filling tray support member and (ii) coupled to the filling support frame;
a second filling linear actuator (i) operatively connected to the nozzle and (ii) coupled to the filling support frame; and
a pump fluidly connected to the nozzle;
a vessel capping assembly including:
a capping support frame;
a capping tray support member;
a first capping linear actuator (i) operatively coupled to the capping tray support member and (ii) coupled to the capping support frame;
a pneumatic torque wrench;
a pneumatic cylinder operatively connected to the pneumatic torque wrench; and
a second capping linear actuator (i) operatively connected to the pneumatic cylinder and (ii) coupled to the capping support frame;
a tray adapted to fit on the filling tray support member and the capping tray support member.

2. The system of claim 1, wherein the tray includes a plurality of receptacles, each one of the plurality of receptacles adapted to receive a container therein.

3. The system of claim 2, wherein the plurality of receptacles are oriented into a grid having a predefined number of columns and rows.

4. The system of claim 1, wherein a stroke (i) of the first filling linear actuator is substantially perpendicular to a stroke of the second filling linear actuator; and (ii) of the first capping linear actuator is substantially perpendicular to a stroke of the second capping linear actuator.

5. The system of claim 1, wherein the pneumatic cylinder raises and lowers the pneumatic torque wrench.

6. The system of claim 1, wherein the pump is a peristaltic pump.

7. The system of claim 1, wherein (i) the filling tray support member includes two or more guides for positioning the tray on the filling tray support member; and (ii) the capping tray support member includes two or more guides for positioning the tray on the capping tray support member.

8. The system of claim 1, wherein the vessel filling assembly further includes:
a control module operatively connected to the first filling linear actuator, the second filling linear actuator, and the pump.

9. The system of claim 1, wherein the capping assembly further includes:
a control module operatively connected to the first capping linear actuator, the second capping linear actuator, and the pneumatic cylinder.

10. A vessel filling and capping system comprising:
a vessel filling assembly including a filling tray support member, a nozzle, a first filling linear actuator operatively coupled to the filling tray support member, a second filling linear actuator operatively connected to the nozzle, and a pump fluidly connected to the nozzle;
a vessel capping assembly including a capping tray support member, a first capping linear actuator operatively coupled to the capping tray support member, a pneumatic torque wrench, a pneumatic cylinder operatively connected to the pneumatic torque wrench, and a second capping linear actuator operatively connected to the pneumatic cylinder;
a tray including a plurality of receptacles oriented into a grid, the tray adapted to fit on the filling tray support member and the capping tray support member; and
a control module operatively connected to the first filling linear actuator, the second filling linear actuator, the pump, the first capping linear actuator, the second capping linear actuator, and the pneumatic cylinder.

11. The system of claim 10, wherein the vessel filling assembly is adapted to fill a plurality of vessels located in the plurality of receptacles of the tray.

12. The system of claim 11, wherein the vessel capping assembly is adapted to cap each of the plurality of vessels filled by the vessel filling assembly.

13. The system of claim 12, wherein the plurality of vessels are each filled and capped while remaining in the tray.

14. The system of claim 10, wherein the plurality of receptacles of the tray are adapted to each receive a vessel therein, the tray being placed on the filling tray support member to be filled by the vessel filling assembly.

15. The system of claim 14, wherein the tray is adapted to be removed from the filling tray support member and moved to the capping support member.

16. The system of claim 15, wherein each of the plurality of vessels are capped after being moved to the capping tray support member by the vessel capping assembly.

17. The system of claim 10, wherein the control module controls a location of the tray via the first filling linear actuator when the tray is placed on the filling tray support member.

18. A method of filling and capping one or more vessels, the method comprising:
providing a vessel filling assembly, the vessel filling assembly including a filling tray support member, a nozzle, a first filling linear actuator operatively coupled to the filling tray support member, a second filling linear actuator operatively connected to the nozzle, and a pump fluidly connected to the nozzle;
providing a vessel capping assembly;
providing a tray, the tray including a plurality of receptacles oriented into a grid;
placing each of the one or more vessels into one of the plurality of receptacles;
placing the tray with the one or more vessels onto the filling tray support member;
filling each of the one or more vessels via the nozzle and the pump;
removing the tray with the one or more vessels being filled; and
placing the tray on the vessel capping assembly to cap each of the one or more vessels.

19. The method of claim 18, wherein the vessel capping assembly includes a capping tray support member, a first capping linear actuator operatively coupled to the capping tray support member, a pneumatic torque wrench, a pneumatic cylinder operatively connected to the pneumatic torque wrench, and a second capping linear actuator operatively connected to the pneumatic cylinder.

20. The method of claim 19, further comprising the steps of:
placing the tray with the one or more vessels onto the capping tray support member;
placing a cap on each of the one or more vessels; and
capping each of the one or more vessels via the pneumatic torque wrench and the pneumatic cylinder.
